(19) United States
(12) Patent Application Publication
(10) Pub. No.: US 2014/0023912 A1
(43) Pub. Date: Jan. 23, 2014

(54) NONAQUEOUS SECONDARY BATTERY AND FILLING METHOD FOR SAME

(71) Applicant: SHARP KABUSHIKI KAISHA, Osaka (JP)

(72) Inventors: Koji OHIRA, Osaka (JP); Hiroshi OKAMOTO, Osaka (JP)

(21) Appl. No.: 13/945,528

(22) Filed: Jul. 18, 2013

(30) Foreign Application Priority Data
Jul. 23, 2012 (JP) 2012-163129

(51) Int. Cl. H01M 2/36

(52) U.S. Cl. CPC H01M 2/36
USPC 429/178; 141/32

(57) ABSTRACT

At least one of holes is formed at a position that is at a higher level than a surface of an electrolyte in use of a nonaqueous secondary battery, and that is not overlapped with an electrode laminate.

### BACKGROUND OF THE INVENTION

1. Field of the Invention

The present invention relates to a nonaqueous secondary battery and a filling method for the nonaqueous secondary battery. It is to be noted that, in this specification, the term “filling” implies an operation of filling an electrolyte into a battery can of the nonaqueous secondary battery.

2. Description of the Related Art

For the purpose of smoothing the filling, there is proposed a technique of forming two holes in a battery can and filling an electrolyte through one of the two holes while exhausting gas (air) through the other hole such that the pressure in the battery can is reduced.

Japanese Unexamined Patent Application Publication No. 10-241741 (publicized Sep. 11, 1998) discloses a technique of, for the purpose of smoothing the filling, forming a plurality of filling holes in a sealing member that seals off an exterior can, and filling an electrolyte through one of the filling holes while exhausting gas through another filling hole such that the pressure in the exterior can is reduced.

However, the technique disclosed in Japanese Unexamined Patent Application Publication No. 10-241741 has the following problem. When the electrolyte is filled into the exterior can from above, bubbles are generated. Therefore, the gas is not smoothly replaced with the electrolyte in an inner space defined by the exterior can and the sealing member, and a filling time is prolonged.

To solve the above-mentioned problem, Japanese Unexamined Patent Application Publication No. 2005-251738 (publicized Sep. 15, 2005) discloses a technique of forming a hole in each of a bottom portion of a container and a sealing member for sealing an opening of the container, and filling an electrolyte through the hole in the bottom portion of the container while gas is exhausted through the hole in the sealing member such that the pressure in the container is reduced.

With the technique disclosed in Japanese Unexamined Patent Application Publication No. 2005-251738, the hole is formed in the bottom portion of the container as viewed in a state of the battery being in use. This results in such a condition that the electrolyte is always contacted with the hole in the bottom portion of the container or a portion closing the hole. Accordingly, there is a risk that the electrolyte may leak out from the container. As another problem, because the electrolyte attaches to the hole in the bottom portion of the container, sealing-off of the hole in the bottom portion of the container is more apt to become insufficient. This also results in a risk that the electrolyte may leak out from the container.

Furthermore, with the technique disclosed in Japanese Unexamined Patent Application Publication No. 10-241741, an electrode assembly is present in the downstream side of the filled electrolyte. Therefore, the electrolyte is supplied to a portion of the electrode assembly in a concentrated way, the portion being positioned just in the downstream side of the filled electrolyte. This raises a difficulty in uniformly infiltrating the electrolyte into the electrode assembly. Hence, there is a fear that a time required to impregnate the entirety of the assembly uniformly with the electrolyte, i.e., a filling time, may be prolonged, or that the battery capacity may be extremely reduced with repeated use of the battery.

### SUMMARY OF THE INVENTION

In view of the problems described above, an object of the present invention is to provide a nonaqueous secondary battery and a filling method for the nonaqueous secondary battery, which are able to avoid the electrolyte from leaking out from a battery can, to shorten the filling time, and to suppress reduction of the battery capacity.

To solve the problems described above, the nonaqueous secondary battery according to the present invention includes an electrolyte, an electrode laminate in which a positive electrode plate and a negative electrode plate are laminated with a separator interposed therebetween, a battery can containing the electrolyte and the electrode laminate, and a plurality of current collection terminals electrically connected to the positive electrode plate and the negative electrode plate, the battery can having a plurality of holes with the function of a filling port for filling the electrolyte into the battery can therethrough and the function of an exhaust port for exhausting gas in the battery can therethrough, wherein at least one of the holes is formed at a position that is at a higher level than a surface of the electrolyte in use of the nonaqueous secondary battery, and that is not overlapped with the electrode laminate.

Furthermore, to solve the problems described above, the filling method according to the present invention includes the step of, when the nonaqueous secondary battery according to the present invention is manufactured, exhausting gas in the battery can through one of any two of the holes and generating a pressure-reduced atmosphere in the battery can while the electrolyte is filled into the battery can through the other of the two holes.

With those features, since the hole is formed at the position not overlapping with the electrode laminate contained in the battery can and the electrolyte is filled through the hole, the electrolyte is able to reach the bottom of the battery can, which is in a state under the filling, without directly striking against the electrode laminate. As a result, it is possible to eliminate portions of the electrode laminate where the electrolyte is otherwise supplied in a concentrated way, and to more easily make the electrode laminate uniformly impregnated with the electrolyte. This contributes to solving the problem that a filling time is prolonged, or that battery capacity is extremely reduced due to repeated use of the battery.

Moreover, the hole is formed at the position that is at a higher level than the surface of the electrolyte in the nonaqueous secondary battery when the nonaqueous secondary battery is in use. Accordingly, the electrolyte can be inhibited from contacting with the hole or a portion closing the hole. As a result, a risk of leakage of the electrolyte from the battery can is reduced.

Preferably, the nonaqueous secondary battery according to the present invention further includes a film material covering surfaces of the electrode laminate where the current collection terminals are not disposed, the film material being made of a material through which the electrolyte is impermeable.

By employing the film material as described above, the electrolyte is caused to infiltrate into the electrode laminate only from the surfaces thereof where the current collection terminals are not disposed.

As a result, in particular, when the nonaqueous secondary battery has a large size, the electrolyte can be more easily infiltrated toward the vicinity of a center of the electrode laminate. Hence the electrode laminate can be uniformly impregnated with the electrolyte at higher reliability.

In the nonaqueous secondary battery according to the present invention, preferably, the at least one hole is formed at a position not overlapping with the current collection terminals.

When the hole is not overlapped with the current collection terminals as well, the electrode laminate can be uniformly impregnated with the electrolyte at even higher reliability.

In the nonaqueous secondary battery according to the present invention, preferably, the battery can includes a container-like case and a cover member serving as a cover of the container-like case, and the at least one hole is formed in the cover member.

With that arrangement, when the nonaqueous secondary battery is in use, the hole is positioned in an upper surface of the nonaqueous secondary battery (specifically, of the battery can). Therefore, the electrolyte can be reliably inhibited from contacting with the hole or the portion closing the hole.

In the nonaqueous secondary battery according to the present invention, preferably, a spacing distance between two of the holes is larger than a size of the electrode laminate measured in a direction parallel to a segment interconnecting the two holes.

The above-mentioned feature can reduce a risk that the electrolyte filled into the battery can through one of the two holes flows out through the other hole.

In the nonaqueous secondary battery according to the present invention, the plural current collection terminals may be disposed side by side at one surface of the electrode laminate.

Preferably, the nonaqueous secondary battery according to the present invention further includes a plurality of external terminals disposed on the battery can and each electrically connected to corresponding one of the plural current collection terminals, and wires electrically connecting the current collection terminals and the external terminals, respectively, the wires being laid to extend along and near an inner wall of the battery can.

With those features, when the filling is performed, as described below, by placing the battery can such that the two holes are positioned at different heights and that an upper one of the two holes is positioned at a higher level than the electrode laminate, the strengths of the current collection terminals, the external terminals, and the wires can be increased. The reason is that, by laying the wires to extend in length with an allowance, the wires can serve to absorb impacts.

In the filling method according to the present invention, preferably, the battery can is placed such that the two holes are positioned at different heights and that an upper one of the two holes is positioned at a higher level than the electrode laminate, and the gas is exhausted through the upper hole.

With the filling method described above, since the gas is exhausted through the upper hole, the electrode laminate can be entirely immersed in the electrolyte. Therefore, the electrode laminate can be uniformly impregnated with the electrolyte at even higher reliability.

As described above, the nonaqueous secondary battery according to the present invention includes the electrolyte, the electrode laminate in which the positive electrode plate and the negative electrode plate are laminated with the separator interposed therebetween, the battery can containing the electrolyte and the electrode laminate, and the plural current collection terminals electrically connected to the positive electrode plate and the negative electrode plate. The battery can has the plural holes with the function of a filling port for filling the electrolyte into the battery can therethrough and the function of an exhaust port for exhausting gas in the battery can therethrough. At least one of the holes is formed at the position that is at a higher level than the surface of the electrolyte in use of the nonaqueous secondary battery, and that is not overlapped with the electrode laminate.

Furthermore, according to the filling method of the present invention, when the nonaqueous secondary battery of the present invention is manufactured, the gas in the battery can is exhausted through one of any two of the holes and a pressure-reduced atmosphere is generated in the battery can while the electrolyte is filled into the battery can through the other of the two holes.

Thus, the present invention can has advantageous effects that the electrolyte can be avoided from leaking out from the battery can, the filling time can be shortened, and reduction of the battery capacity can be suppressed.

### BRIEF DESCRIPTION OF THE DRAWINGS

FIG. 1 is a perspective view illustrating the structure of a nonaqueous secondary battery according to one embodiment of the present invention.

FIG. 2 is a graph depicting the comparison results among EXAMPLES 1 to 3 and COMPARATIVE EXAMPLE.

FIG. 3 is a perspective view illustrating the structure of a nonaqueous secondary battery according to a first modification related to the structure illustrated in FIG. 1.

FIG. 4 is a perspective view illustrating the structure of a nonaqueous secondary battery according to a second modification related to the structure illustrated in FIG. 1.

FIG. 5 is a perspective view illustrating the structure of a nonaqueous secondary battery as a comparative example related to the nonaqueous secondary battery illustrated in FIG. 4.

FIG. 6 is a perspective view illustrating the configuration of principal part of a filling device for the nonaqueous secondary battery according to one embodiment of the present invention.

FIG. 7 is a conceptual image illustrating a filling device and a filling method for a nonaqueous secondary battery according to related art.

FIG. 8 is a perspective view illustrating a practical example of the configuration of a pressure adjusting mechanism.

FIG. 9 is a perspective view illustrating the configuration adapted for filling using a pressure reducing chamber.

FIG. 10 is a perspective view illustrating a simplified modification of the configuration of the filling device illustrated in FIG. 6.

FIG. 11 illustrates one example of on-off timings of electromagnetic valves and a pressure regulating valve when an electrolyte is filled using the filling device illustrated in FIG. 6.

FIG. 12 illustrates one example of on-off timings of the electromagnetic valves and the pressure regulating valve when an electrolyte is filled using the filling device illustrated in FIG. 10.

### DESCRIPTION OF THE PREFERRED EMBODIMENTS

### Nonaqueous Secondary Battery and Filling Method for Same

### [Basic Structure]

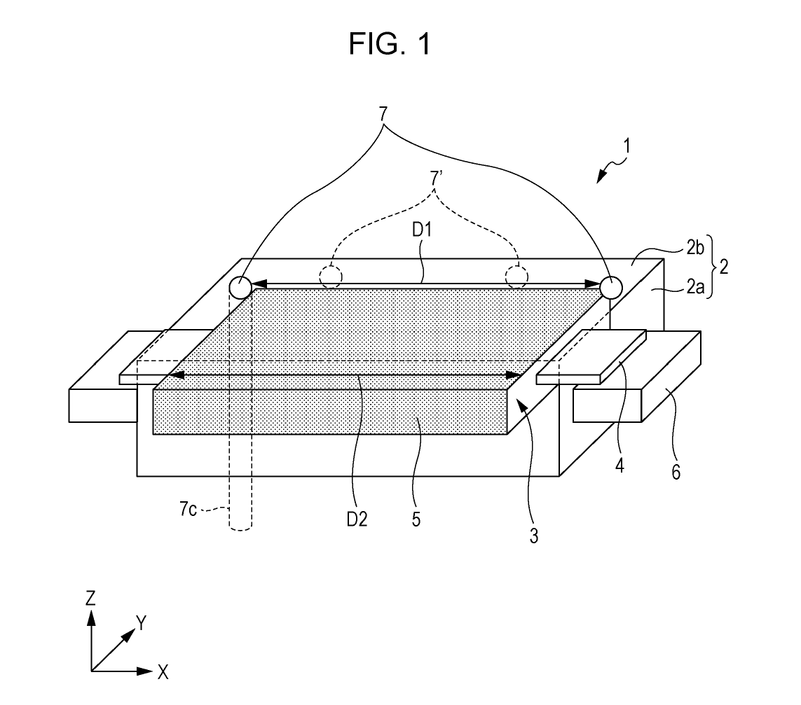

FIG. 1 is a perspective view illustrating the structure of a nonaqueous secondary battery according to one embodiment.

A nonaqueous secondary battery 1 illustrated in FIG. 1 includes a battery can 2, an electrode laminate 3, a current collection terminal 4, a heat shrinkable film 5, and an external terminal 6.

In FIG. 1, three directions orthogonal to one another, i.e., X-, Y- and Z-directions, are defined as per illustrated. The battery can 2 of the nonaqueous secondary battery 1 is substantially in the form of a rectangular parallelepiped. Surfaces of the rectangular parallelepiped are each parallel to two of the X-, Y- and Z-directions.

The battery can 2 is formed, for example, by pressing a metal plate, and it includes a container-like case 2a and a cover member 2b. The battery can 2 is made of, e.g., iron, nickel-plated iron, stainless steel, or aluminum. Two holes 7 are formed in the cover member 2b. Details of the holes 7 will be described later.

In use of the nonaqueous secondary battery 1, the cover member 2b is positioned at an upper surface of the nonaqueous secondary battery 1 (specifically, of the battery can 2).

The electrode laminate 3 is contained inside the battery can 2. Though not illustrated for the sake of simplicity of the drawing, the electrode laminate 3 is constituted by stacking a plurality of units (lamination units) in each of which a positive electrode plate and a negative electrode plate are laminated with a separator interposed between them. While, in the nonaqueous secondary battery 1, the electrode laminate 3 is substantially in the form of a hexahedron, the shape of the electrode laminate is not limited to particular one.

While an electrolyte is not illustrated in FIG. 1 for the sake of simplicity of the drawing, the electrolyte is contained in the battery can 2 in which the electrode laminate 3 is also contained. After filling the electrolyte, the holes 7 are closed, whereby the nonaqueous secondary battery 1 is completed.

The current collection terminal 4 is provided in number two. One of the two current collection terminals 4 is electrically connected to the above-mentioned positive electrode plate, and the other is electrically connected to the above-mentioned negative electrode plate.

In the nonaqueous secondary battery 1, the two current collection terminals 4 are disposed respectively at a surface of the electrode laminate 3, which constitutes one end of the electrode laminate 3 in the X-direction, and at another surface of the electrode laminate 3, which constitutes the other end of the electrode laminate 3 in the X-direction. Stated in another way, the two current collection terminals 4 are disposed to face each other in the horizontal direction with the electrode laminate 3 interposed between them when the nonaqueous secondary battery 1 is in use.

The heat shrinkable film (film material) 5 covers four surfaces of the electrode laminate 3 where the current collection terminals 4 are not disposed. More specifically, the heat shrinkable film 5 is wound around each of the lamination units constituting the electrode laminate 3. The heat shrinkable film 5 is made of a material through which the electrolyte is impermeable. Therefore, the electrolyte does not infiltrate into the electrode laminate 3 from portions of the electrode laminate 3, which are covered with the heat shrinkable film 5, (typically through the above-mentioned four surfaces). Various materials including polyethylene (PE), polyethylene terephthalate (PET), polypropylene (PP), polystyrene (PS), and polyolefin (PO), for example, can be optionally suitably used for the heat shrinkable film 5.

The external terminal 6 is provided in number two, which are electrically connected to the two current collection terminals 4 in one-to-one relation.

In the nonaqueous secondary battery 1, the two external terminals 6 are disposed respectively at a surface of the battery can 2, which constitutes one end of the battery can 2 in the X-direction, and at another surface of the battery can 2, which constitutes the other end of the battery can 2 in the X-direction. Stated in another way, the two external terminals 6 are disposed to face each other in the horizontal direction with the battery can 2 interposed between them when the nonaqueous secondary battery 1 is in use.

The holes 7 are formed, as described above, in number two in the cover member 2b of the battery can 2. The holes 7 have the function of a filling port for filling the electrolyte into the battery can 2 therethrough (i.e., through which the electrolyte is filled), and the function of an exhaust port for exhausting gas inside the battery can 2 therethrough.

The holes 7 are disposed at positions not overlapping with the electrode laminate 3 contained in the battery can 2. Furthermore, the holes 7 are preferably disposed at positions not overlapping with the current collection terminals 4 as well.

More specifically, as illustrated in FIG. 1, each hole 7 is disposed such that a right column 7c or an oblique column (not illustrated), which has a bottom surface defined by the hole 7, does not overlap with at least the electrode laminate 3, preferably both the electrode laminate 3 and the current collection terminals 4.

It is to be noted that, in the nonaqueous secondary battery 1, a spacing distance D1 between the two holes 7 is larger than a dimension D2 of the electrode laminate 3 in a direction parallel to a segment interconnecting the two holes 7.

### [Practical Example of Method for Manufacturing Nonaqueous Secondary Battery]

A practical example of a method for manufacturing the nonaqueous secondary battery according to the embodiment will be described below.

### [Fabrication of Positive Electrode Plate]

LiFePO₄ (90 parts by weight) as a positive active material, acetylene black (5 parts by weight) as a conductive material, and polyvinylidene fluoride (5 parts by weight) as a binder are mixed together. Slurry is prepared by adding, as a solvent, an appropriate amount of N-methyl-2-pyrrolidone to the mixture, and causing the above-mentioned materials to be dispersed in the solvent. The positive electrode plate is fabricated by uniformly coating the slurry over both surfaces of an aluminum foil (thickness of 20 μm), which serves as a positive current collector, drying the coated slurry, compressing the dried slurry with a roll press, and cutting the aluminum foil into individual plates each having a predetermined size.

The positive electrode plate thus fabricated has a size of 145 mm×298 mm and a thickness of 230 μm. The lamination unit is fabricated by employing the nine positive electrode plates.

### [Fabrication of Negative Electrode Plate]

Natural graphite (black lead) (90 parts by weight) as a negative active material and polyvinylidene fluoride (10 parts by weight) as a binder are mixed together. Slurry is prepared by adding, as a solvent, an appropriate amount of N-methyl-2-pyrrolidone to the mixture, and causing the above-mentioned materials to be dispersed in the solvent. The negative electrode plate is fabricated by uniformly coating the slurry over both surfaces of a copper foil (thickness of 16 μm), which serves as a negative current collector, drying the coated slurry, compressing the dried slurry with a roll press, and cutting the copper foil into individual plates each having a predetermined size.

The negative electrode plate thus fabricated has a size of 153 mm×306 mm and a thickness of 146 μm. The lamination unit is fabricated by employing the ten negative electrode plates.

### [Fabrication of Separator]

A polyethylene film having a size of 155 mm×311 mm and a thickness of 25 μm is fabricated as a separator.

### [Fabrication of Nonaqueous Electrolyte]

A nonaqueous electrolyte is prepared by dissolving 1 mol/L of LiPF₆ in a mixed solution (solvent) in which ethylene carbonate (EC) and diethylene carbonate (DEC) are mixed at a volume ratio of 30:70.

### [Fabrication of Battery Can]

Plates made of nickel-plated iron are used as materials of the container-like case 2a and the cover member 2b, which constitute the battery can 2. The battery can 2 has a wall thickness of 0.8 mm and a size of 330 mm (lengthwise direction)×157 mm (widthwise direction)×41 mm (depth) (internal dimensions). The two holes 7 capable of being opened and closed are formed in the cover member 2b. In order to make the cover member 2b closely contacted with an upper surface of the electrode laminate 3, the cover member 2b is formed, instead of being in a flat plate shape, in a saucer-like shape such that the cover member 2b is concavely fitted into the battery can 2. Using the cover member 2b in the saucer-like shape can prevent the cover member 2b from being moved when the cover member 2b is welded, and hence can facilitate the welding operation. Moreover, by changing an amount by which the saucer-like shape of the cover member 2b is recessed downwards, it is more easily adaptable for change in the thickness of the electrode laminate 3 to be set in the battery can 2. In addition, using the cover member 2b in the saucer-like shape is preferable in increasing the strength of the cover member 2b and the strength of the battery can 2.

### [Assembly of Secondary Battery]

The positive electrode plates and the negative electrode plates are alternately laminated with the separators interposed between them. At that time, the nine positive electrode plates, the ten negative electrode plates, and the eighteen separators are laminated such that the negative electrode plates are positioned in the outer side than the positive electrode plates. A polyethylene film having the same thickness, i.e., 25 μm, as that of the separator and serving as the heat shrinkable film 5 is wound over a plate assembly obtained as mentioned above, whereby the lamination unit is fabricated. The electrode laminate 3 is constituted by stacking the lamination unit in eight stages.

The size of the separator interposed between the positive electrode plate and the negative electrode plate is 155 mm×311 mm, as mentioned above, and it is slightly larger than the size (145 mm×298 mm) of the positive electrode plate and the size (153 mm×306 mm) of the negative electrode plate. With such size setting, active material layers formed in the positive electrode plates and the negative electrode plates can be reliably covered with the separators. Connection pieces of the current collection terminals 4 are connected respectively to exposed portions of the positive current collectors and exposed portions of the negative current collectors, those exposed portions being not covered with the heat shrinkable films 5.

The electrode laminate 3 to which the current collection terminals 4 have been connected is set in the container-like case 2a, and the current collection terminals 4 are connected to the external terminals 6. Furthermore, the cover member 2b is attached in place and the electrode laminate 3 is sealed off. In that state, the holes 7 are disposed in the cover member 2b at positions not overlapping with both the electrode laminate 3 and the current collection terminals 4, which have already been set in the container-like case 2a. Thereafter, the filling is performed by filling the nonaqueous electrolyte into the battery can 2 using the two holes 7. At that time, a pressure-reduced atmosphere is generated in the battery can 2 by exhausting gas through one of the two holes 7, while the nonaqueous electrolyte is filled into the battery can 2 through the other hole 7. After the filling, the two holes 7 are sealed off, whereby the nonaqueous secondary battery is fabricated.

### Example 1

The nonaqueous secondary battery 1 was fabricated in accordance with the above-described method for fabricating the nonaqueous secondary battery.

Furthermore, the filling was performed in a state where the battery can 2 was placed with the X-direction in FIG. 1 being oriented in the vertical direction (i.e., the direction of gravity).

When the battery can 2 was placed with the X-direction in FIG. 1 being oriented in the vertical direction, the two holes 7 were positioned at different heights and upper one of the two holes 7 was located at a higher position than the electrode laminate 3. The gas in the battery can 2 was exhausted through the upper hole 7, and the electrolyte was filled through the lower hole 7.

### Example 2

The following nonaqueous secondary battery (hereinafter referred to as a “nonaqueous secondary battery 1a”) was fabricated in accordance with the above-described method for fabricating the nonaqueous secondary battery.

More specifically, the nonaqueous secondary battery 1a had the same structure as the nonaqueous secondary battery 1 except that the heat shrinkable films 5 were omitted in the nonaqueous secondary battery 1a.

Furthermore, the filling was performed in a state where the battery can 2 was placed with the X-direction in FIG. 1 being oriented in the vertical direction.

### Example 3

The nonaqueous secondary battery 1a was fabricated in the same manner as that in EXAMPLE 2 in accordance with the above-described method for fabricating the nonaqueous secondary battery.

However, the filling was performed in a state where the battery can 2 was placed with the Z-direction in FIG. 1 being oriented in the vertical direction.

### Comparative Example

The following nonaqueous secondary battery (hereinafter referred to as a “nonaqueous secondary battery 1b”) was fabricated in accordance with the above-described method for fabricating the nonaqueous secondary battery.

More specifically, the nonaqueous secondary battery 1b had the same structure as the nonaqueous secondary battery 1a except that the holes 7 were omitted, and that other holes (i.e., holes 7′ illustrated in FIG. 1) were formed at positions overlapping with the electrode laminate 3.

Furthermore, the filling was performed in the state where the battery can 2 was placed with the Z-direction in FIG. 1 being oriented in the vertical direction.

[Comparison Results among EXAMPLES 1 to 3 and COMPARATIVE EXAMPLE]

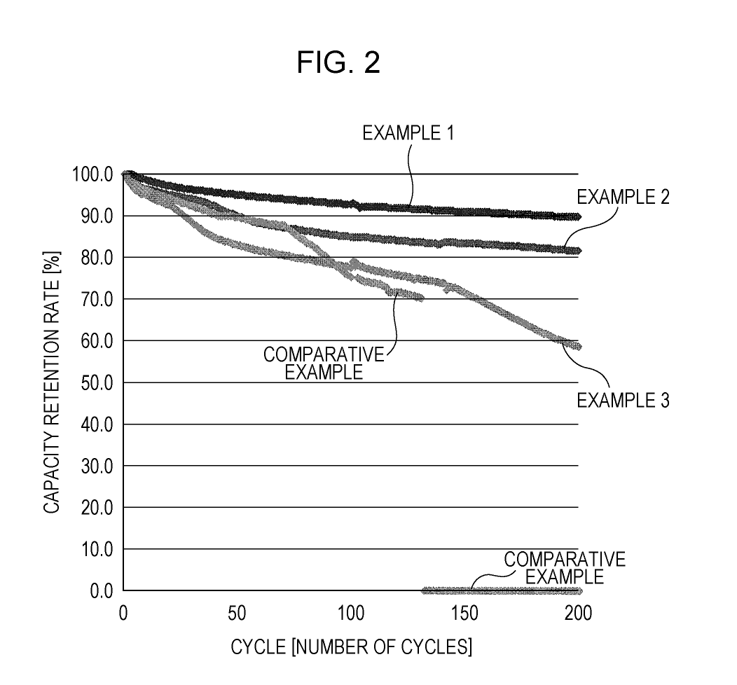

FIG. 2 is a graph depicting the comparison results among the above-described EXAMPLES 1 to 3 and COMPARATIVE EXAMPLE. In other words, FIG. 2 is a graph depicting the relationship between the number of cycles and a capacity retention rate. More specifically, FIG. 2 illustrates the results of cycle tests.

In COMPARATIVE EXAMPLE, the battery capacity was reduced to 0 at the number of cycles between 100 and 150. It is thought that such an event is caused because of internal short-circuiting in the nonaqueous secondary battery 1b.

[Operating Advantages with Structure of Nonaqueous Secondary Battery 1]

By forming the holes 7 at the positions not overlapping with the electrode laminate 3 set in the battery can 2 and performing the filling using the holes 7, the electrolyte is allowed to reach the bottom of the battery can 2, which is in the state under the filling, without directly striking against the electrode laminate 3. As a result, it is possible to eliminate portions of the electrode laminate 3 where the electrolyte is otherwise supplied in a concentrated way, and to more easily make the electrode laminate 3 uniformly impregnated with the electrolyte. When the holes 7 are not overlapped with the current collection terminals 4 as well, the electrode laminate 3 can be uniformly impregnated with the electrolyte at higher reliability.

In the structure of the nonaqueous secondary battery 1, the electrode laminate 3 is set in the battery can 2 such that the electrode laminate 3 is not closely fitted in the battery can 2. In other words, in the state where the electrode laminate 3 is set in the battery can 2, there is a space inside the battery can 2 where the electrode laminate 3 does not exist. Thus, the holes 7 are just required to be formed in overlapped relation to such a space.

Furthermore, the holes 7 are formed in the cover member 2b. In other words, when the nonaqueous secondary battery 1 is in use, the holes 7 are positioned at the upper surface of the nonaqueous secondary battery 1 (specifically, of the battery can 2). Therefore, the electrolyte is inhibited from contacting with the holes 7 or portions closing the holes 7. As a result, a risk of leakage of the electrolyte from the battery can 2 can be reduced.

Moreover, when the filling is performed, the holes 7 are not required to be positioned at the bottom side. Accordingly, when a filling nozzle is withdrawn from the hole 7, a risk of the electrolyte being attached to the vicinity of the hole 7 can be reduced. As a result, factors adversely affecting the sealing-off of the hole 7 can be reduced.

In particular, when the filling is performed in the state where the battery can 2 is placed with the Z-direction in FIG. 1 being oriented in the vertical direction, it is no longer required to fit rubber plugs in the holes 7 so that the electrolyte will not spill out until the holes 7 are sealed off. As a result, a risk of leakage of the electrolyte due to deterioration of the rubber plugs and a risk of mixing of foreign matters into the battery can 2 can be reduced.

On the other hand, when the filling is performed in the state that the battery can 2 is placed with the X-direction in FIG. 1 being oriented in the vertical direction, the filling is preferably performed by determining the orientation of the battery can 2 such that the two holes 7 are positioned at different heights and upper one of the two holes 7 is positioned at a higher level than the electrode laminate 3.

In that case, by exhausting gas in the battery can 2 through the upper hole 7, the entire surface of the electrode laminate 3 can be immersed in the electrolyte. Therefore, the electrode laminate 3 can be uniformly impregnated with the electrolyte at higher reliability. On the other hand, the lower hole 7 through which the electrolyte is filled is preferably located at a position as low as possible. This is because such an arrangement of the lower hole 7 can further reduce a possibility that the electrolyte may directly strike against the electrode laminate 3 during the filling. By setting the spacing distance D1 between the two holes 7 to a sufficiently large value, the lower hole 7 can be easily located at a sufficiently low position.

Moreover, when the heat shrinkable films 5 are used, the electrolyte is caused to enter the electrode laminate 3 only through portions of the electrode laminate 3, the portions being not covered with the heat shrinkable films 5, i.e., through two surfaces of the electrode laminate 3 where the current collection terminals 4 are disposed.

As a result, particularly when the size of the nonaqueous secondary battery 1 is large, the electrolyte can be more easily infiltrated toward the vicinity of a center of the electrode laminate 3, and the electrode laminate 3 can be uniformly impregnated with the electrolyte at higher reliability.

As described above, the nonaqueous secondary battery 1 has the advantage that the electrode laminate 3 can be uniformly impregnated with the electrolyte in an easy manner. With that advantage, it is possible to perform the filling at a higher speed, and to suppress reduction of the battery capacity caused by repeated use of the battery.

While, in the nonaqueous secondary battery 1 described above, the two holes 7 are each a circular hole, the shape of the hole 7 is not limited to a circle, and the hole 7 may have any other suitable shape, e.g., a rectangular shape.

Furthermore, in the nonaqueous secondary battery 1, the two holes 7 are each formed at the position not overlapping with the electrode laminate 3 and preferably formed at the position not overlapping with the current collection terminals 4 as well. However, only one of the two holes 7 may be positioned at the above-mentioned position.

While, in the nonaqueous secondary battery 1, the holes 7 are formed in the cover member 2b, the holes 7 are not always required to be formed in the cover member 2b. Stated in another way, the holes 7 are preferably formed at a position higher than the surface of the electrolyte in use of the nonaqueous secondary battery 1.

While the two holes 7 are formed in the nonaqueous secondary battery 1, the number of the holes 7 is not limited to two, and three or more holes may be formed.

Moreover, in the nonaqueous secondary battery 1, the heat shrinkable film 5 is not an essential component and it may be dispensed with.

Additionally, when the filling is performed, the height of the surface of the electrolyte inside the battery can 2 is controlled, in consideration of the progress in infiltration of the electrolyte into the electrode laminate 3, such that the electrolyte surface will not excessively rise through a space where the electrode laminate 3 does not exist.

### First Modification

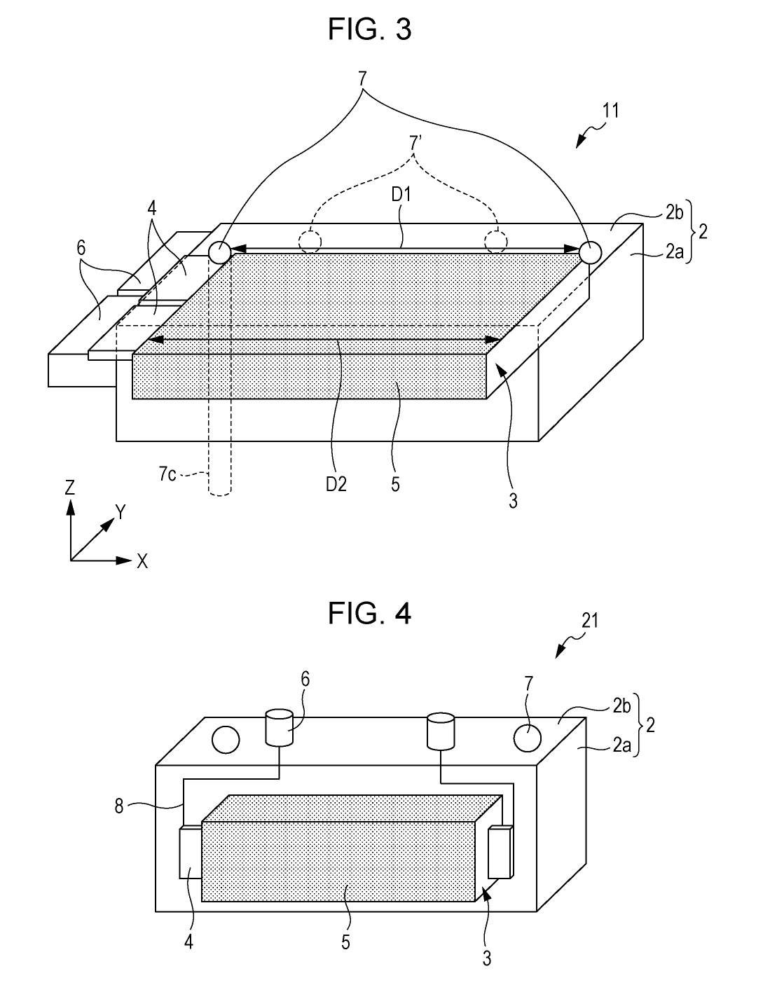

FIG. 3 is a perspective view illustrating the structure of a nonaqueous secondary battery according to a first modification related to the structure illustrated in FIG. 1.

A nonaqueous secondary battery 11 illustrated in FIG. 3 differs from the nonaqueous secondary battery 1 illustrated in FIG. 1 in the positions of the two current collection terminals 4 and the two external terminals 6. The remaining structure of the nonaqueous secondary battery 11 is the same as that of the nonaqueous secondary battery 1 illustrated in FIG. 1.

More specifically, in the nonaqueous secondary battery 11, the two current collection terminals 4 are disposed side by side at a surface of the electrode laminate 3, which constitutes one end of the electrode laminate 3 in the X-direction, i.e., at one surface of the electrode laminate 3 in the X-direction.

Similarly, in the nonaqueous secondary battery 11, the two external terminals 6 are disposed side by side at the surface of the battery can 2, which constitutes the one end of the battery can 2 in the X-direction, i.e., at the one surface of the battery can 2 in the X-direction.

### Second Modification

FIG. 4 is a perspective view illustrating the structure of a nonaqueous secondary battery according to a second modification related to the structure illustrated in FIG. 1.

In a nonaqueous secondary battery 21 illustrated in FIG. 4, the two external terminals 6 are disposed side by side on the upper surface of the battery can 2 (typically on the cover member 2b). In the nonaqueous secondary battery 21, the two current collection terminals 4 are disposed at the same positions as those in the nonaqueous secondary battery 1 illustrated in FIG. 1.

Furthermore, the current collection terminals 4 and the external terminals 6 are electrically connected by wires 8, and the wires 8 are laid to extend along and near an inner wall of the battery can 2. Such an arrangement can increase the strengths of the current collection terminals 4, the external terminals 6, and the wires 8 when the filling is performed in a state where the battery can 2 is placed such that the two holes 7 are positioned at different heights and upper one of the two holes 7 is positioned at a higher level than the electrode laminate 3 (see EXAMPLES 1 and 2). The reason is that, by laying the wires 8 to extend in length with an allowance, the wires 8 can serve to absorb impacts.

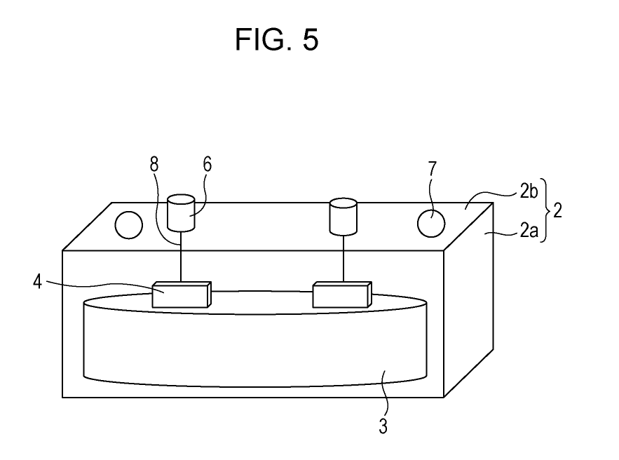

On the other hand, as illustrated in FIG. 5 representing a comparative example, when the current collection terminals 4, the external terminals 6, and the wires 8 are disposed in such an arrangement as connecting the current collection terminals 4 and the external terminals 6 in the shortest distances, there is a risk that the strengths of the current collection terminals 4, the external terminals 6, and the wires 8 may be reduced when the battery can 2 is placed as mentioned above during the filling.

Furthermore, in comparison with the comparative example illustrated in FIG. 5, a connection area between the electrode laminate 3 and each current collection terminal 4 can be more easily increased in the second modification illustrated in FIG. 4 because of less possibility of short-circuiting. Therefore, the strength of the current collection terminal 4 can be increased in the second modification illustrated in FIG. 4. In addition, the electrode laminate 3 and the current collection terminal 4 have a line-shaped connection surface in a size of several millimeters×several centimeters. Accordingly, when the battery is turned to a longer-side standing state where the plural holes 7 are arranged side by side in the vertical direction during the filling, the second modification illustrated in FIG. 4 can bear stress, which is applied to a connecting portion between the electrode laminate 3 and the current collection terminal 4, at a larger area than in the comparative example illustrated in FIG. 5, whereby the strength is increased in the second modification.

### [Recapitulation]

The nonaqueous secondary battery 1 according to the present invention can also be construed as follows.

The electrolyte can be more easily infiltrated into the electrode laminate 3 in one direction from a bottom portion of the battery can 2 toward an upper portion thereof as viewed in the state under the filling without forming the holes 7 in a bottom portion of the battery can 2 as viewed in the state under use of the battery. Therefore, a risk of the electrolyte being contacted with the portions closing the holes 7 can be reduced, and reliability of the battery is improved.

The holes 7 and the electrode laminate 3 are arranged in such a positional relationship that the above-mentioned infiltration in the one direction is facilitated in spite of the holes 7 being formed in the cover member 2b.

By properly defining the connecting structure of the current collection terminals 4 and the external terminals 6, the battery can 2 can be turned to the longer-side standing state, whereby the above-mentioned infiltration in the one direction is further facilitated.

The cover member 2b includes the plural holes 7, and at least one of the plural holes 7 is present in the outer side than the electrode end of the electrode laminate 3. Such an arrangement can suppress abrupt reduction of the battery capacity, which occurs in the above-described COMPARATIVE EXAMPLE. Such an arrangement further contributes to facilitating the above-mentioned infiltration in the one direction.

Moreover, the heat shrinkable films 5 through which the electrolyte is impermeable are disposed as outermost layers of the electrode laminate 3. Such an arrangement can suppress the infiltration of the electrolyte into the electrode laminate 3 through the four surfaces of the electrode laminate 3, which are covered with the heat shrinkable films 5. As a result, the filling in the one direction can be performed with higher reliability.

By welding a metal plate for sealing-off when the hole 7 is sealed off, mixing of moisture into the battery can 2 can be suppressed. More specifically, the mixing of moisture into the battery can 2 can be suppressed for a long term of 10 or more years unlike the case of sealing off the hole with a thermally fusible resin.

In particular, by setting the spacing distance D1 between the two holes 7 to be larger than the dimension D2 of the electrode laminate 3 in the direction parallel to the segment interconnecting the two holes 7, as illustrated in FIG. 1, the following advantage can be obtained. Thus, it is possible to reduce the risk that the electrolyte filled into the battery can 2 through the one hole 7 may flow out through the other hole 7.

### [Filling Device and Filling Method for Nonaqueous Secondary Battery]

### Problems with Related Art

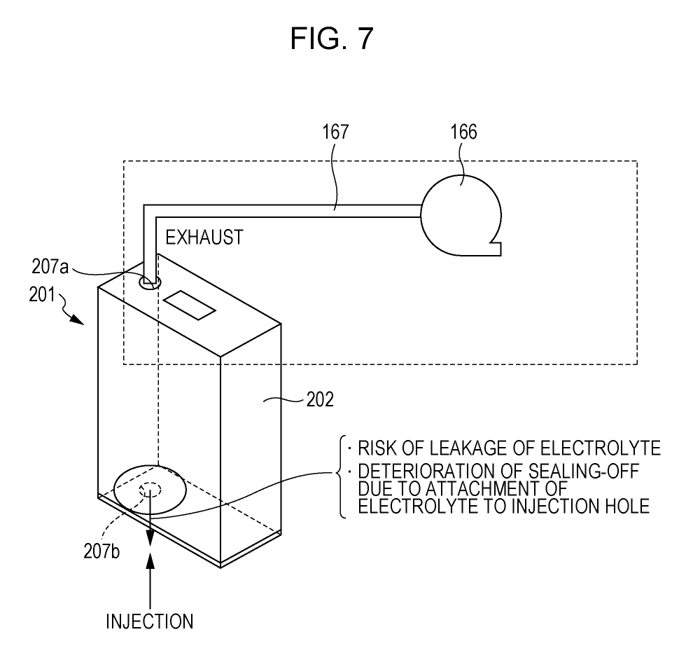

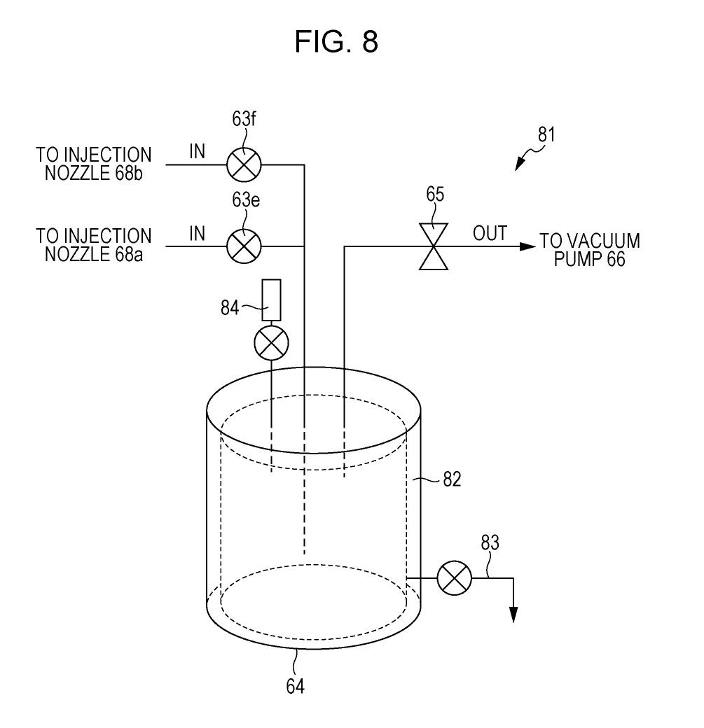

FIG. 7 is a conceptual image illustrating a filling device and a filling method for a nonaqueous secondary battery according to related art.

A nonaqueous secondary battery 201 illustrated in FIG. 7 includes two holes 207a and 207b, which are formed in an upper surface and a bottom surface of a battery can 202, respectively.

An electrolyte is filled through the hole 207b formed in the bottom surface of the battery can 202 while gas in the battery can 202 is exhausted through the hole 207a formed in the upper surface of the battery can 202 by employing a vacuum pump 166 such that a pressure-reduced atmosphere is generated in the battery can 202.

It is to be noted that the “upper surface of the battery can 202” and the “bottom surface of the battery can 202” are not changed between the state where the filling is performed and the state where the nonaqueous secondary battery 201 is used.

With the filling device and the filling method for the nonaqueous secondary battery 201 illustrated in FIG. 7, however, there is a risk that pressure is excessively reduced immediately after starting to reduce the pressure in the battery can 202 by the vacuum pump 166. The electrolyte having the low boiling point volatilizes upon the excessive pressure reduction in the battery can 202. With the volatilization of the electrolyte, gas is generated and the pressure is caused to rise after that. Thus, a difficulty occurs in properly controlling the pressure (degree of vacuum) in the battery can 202. In addition, there is a risk that the composition of the electrolyte may change due to the volatilization of the electrolyte and quality of the electrolyte may become instable.

Furthermore, a path 167 between the hole 207a and the vacuum pump 166 is generally formed of a thin vacuum pipe. When such a thin vacuum pipe is used, severe pressure adjustment is required for the inside of the battery can 202, and the severe pressure adjustment is difficult to carry out in practice.

### [Configuration of Filling Device]

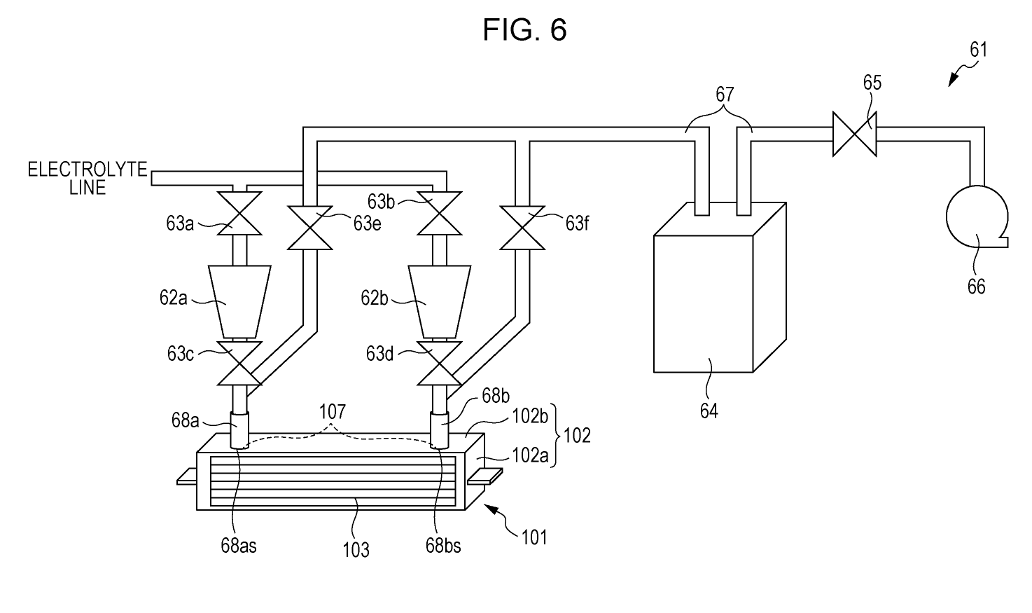

FIG. 6 is a perspective view illustrating the configuration of principal part of a filling device for the nonaqueous secondary battery according to one embodiment.

A filling device 61 illustrated in FIG. 6 is used to perform the filling for a nonaqueous secondary battery 101. In the nonaqueous secondary battery 101, an electrode laminate 103 is set in a battery can 102, and two holes 107 each optionally having the function of a filling port or an exhaust port are formed in one or more surfaces of the battery can 102 other than a bottom surface thereof (preferably in a cover member 102b). As a matter of course, any of the nonaqueous secondary battery 1 (see FIG. 1), the nonaqueous secondary battery 11 (see FIG. 3), and the nonaqueous secondary battery 21 (see FIG. 4) is preferably used as the nonaqueous secondary battery 101.

The filling device 61 includes hopper tanks 62a and 62b, electromagnetic valves 63a to 63f, a pressure regulating container 64, a pressure regulating valve 65, a vacuum pump 66, a vacuum line 67, and filling nozzles 68a and 68b.

The hopper tank 62a is connected to a path (electrolyte line) through which an electrolyte to be supplied for the filling from an electrolyte tank (not illustrated) flows. The electromagnetic valve 63a is disposed in the electrolyte line that is connected to the hopper tank 62a. When the electromagnetic valve 63a is opened, the relevant electrolyte line is held open, and when it is closed, the relevant electrolyte line is shut off.

The filling nozzle 68a is connected to the hopper tank 62a. The electromagnetic valve 63c is disposed in a path extending from the hopper tank 62a to a distal end 68 as of the filling nozzle 68a. When the electromagnetic valve 63c is opened, the relevant path is held open, and when it is closed, the relevant path is shut off.

The hopper tank 62b is connected to the electrolyte line. The electromagnetic valve 63b is disposed in the electrolyte line that is connected to the hopper tank 62b. When the electromagnetic valve 63b is opened, the relevant electrolyte line is held open, and when it is closed, the relevant electrolyte line is shut off.

The filling nozzle 68b is connected to the hopper tank 62b. The electromagnetic valve 63d is disposed in a path extending from the hopper tank 62b to a distal end 68bs of the filling nozzle 68b. When the electromagnetic valve 63d is opened, the relevant path is held open, and when it is closed, the relevant path is shut off.

The filling nozzle 68a and the filling nozzle 68b are fixedly held in such a state that their distal ends 68 as and 68bs are positioned in alignment with the holes 107 in one-to-one relation. Each of the filling nozzle 68a and the filling nozzle 68b optionally serves as a nozzle for filling the electrolyte, which is supplied via the electrolyte line, into the battery can 102 through the hole 107, and as a nozzle for exhausting gas in the battery can 102 to the vacuum line 67 through the hole 107.

The vacuum line 67 is arranged such that it is branched from a path between the electromagnetic valve 63c and the distal end 68 as of the filling nozzle 68a and is branched from a path between the electromagnetic valve 63d and the distal end 68bs of the filling nozzle 68b. The electromagnetic valve 63e is disposed in the vacuum line 67 in communication with the filling nozzle 68a. When the electromagnetic valve 63e is opened, the relevant vacuum line 67 is held open, and when it is closed, the relevant vacuum line 67 is shut off. The electromagnetic valve 63f is disposed in the vacuum line 67 in communication with the filling nozzle 68b. When the electromagnetic valve 63f is opened, the relevant vacuum line 67 is held open, and when it is closed, the relevant vacuum line 67 is shut off.

One end of the pressure regulating container 64 is connected to a section of the vacuum line 67 on the same side as the filling nozzles 68a and 68b, and the other end of the pressure regulating container 64 is connected to a section of the vacuum line 67 on the same side as the vacuum pump 66. The pressure regulating container 64 is constituted in accordance with the principle of operation of a buffer tank, and it operates as a main part of a pressure regulating mechanism for suppressing abrupt variations of the pressure in a region spanning from the battery can 102 to the vacuum line 67. Details of the pressure regulating mechanism will be described below.

When the pressure regulating valve 65 is opened, the pressure reduction by the vacuum pump 66 is enabled, and when the pressure regulating valve 65 is closed, the pressure reduction by the vacuum pump 66 is disabled regardless of whether the electromagnetic valves 63e and 63f are opened or closed.

The vacuum pump 66 operates to reduce the pressure in the battery can 102 through the vacuum line 67 in which the pressure regulating container 64 is disposed.

FIG. 8 is a perspective view illustrating a practical example of the configuration of a pressure adjusting mechanism 81.

As illustrated in FIG. 8, the pressure regulating mechanism 81 includes the electromagnetic valves 63e and 63f, the pressure regulating container 64, the pressure regulating valve 65, a cooling mechanism 82, a drain 83, and a negative pressure relief valve 84.

The cooling mechanism 82 serves to cool the pressure regulating container 64, thereby lowering the temperature in the pressure regulating container 64. The cooling mechanism 82 can be constituted by employing, e.g., a cooling coil built in the pressure regulating container 64, or a mechanism for circulating cooling water along and near an outer wall of the pressure regulating container 64.

The drain 83 includes a pipe (drain pipe) and a plug (including a drain valve and a drain cap). The drain 83 serves to discharge a liquid staying at the bottom of the pressure regulating container 64 to the outside.

The negative pressure relief valve 84 is opened when the pressure in the pressure regulating container 64 is reduced to be negative with respect to a predetermined value, thereby preventing the pressure in the pressure regulating container 64 and the pressure in the battery can 102 from being extremely lowered.

When the filling is performed, the filling nozzle 68a is fixed to one hole 107 and the filling nozzle 68b is fixed to the other hole 107 as a first step.

Thereafter, the electrolyte is filled into the battery can 102 through the one hole 107 using the filling nozzle 68a, while gas in the battery can 102 is exhausted through the other hole 107 using the filling nozzle 68b.

At that time, the electrolyte supplied to the hopper tank 62a via the electrolyte line is filled into the battery can 102 through the filling nozzle 68a. In addition, at that time, the gas in the battery can 102 is exhausted by the vacuum pump 66 through the filling nozzle 68b and the vacuum line 67, whereby the pressure in the battery can 102 is reduced.

Herein, as described above, the pressure regulating mechanism 81 is constituted in accordance with the principle of operation of a buffer tank, and it operates to suppress abrupt variations of the pressure in a region spanning from the battery can 102 to the vacuum line 67.

More specifically, when the pressure in the vacuum line 67 is reduced by operating the vacuum pump 66, the pressure in the pressure regulating container 64 is also reduced together. As a result, pressure variations in the vacuum line 67 become more moderate than when the pressure in the vacuum line 67 alone is reduced without providing the pressure regulating mechanism 81. Thus, the pressure regulating mechanism 81 enables the pressure in the vacuum line 67 and further the pressure in the battery can 102 to vary more moderately.

Thus, by employing the filling device 61 including the pressure regulating mechanism 81 to fill the electrolyte into the nonaqueous secondary battery 101, the risk of excessive pressure reduction can be reduced which may otherwise occur immediately after starting to reduce the pressure in the battery can 102 by the vacuum pump 66. Therefore, volatilization of the electrolyte having the low boiling point can be suppressed. Moreover, even if the electrolyte volatilizes and gas generates, a pressure rise due to the generation of the gas can be held down and a pressure level can be easily reduced again. In other words, it is possible to facilitate proper control of the pressure (degree of vacuum) in the battery can 102, and to reduce the risk that the composition of the electrolyte may change due to the volatilization of the electrolyte and quality of the electrolyte may become instable.

Generally, the vacuum line 67 is formed of a thin vacuum pipe. However, even when such a thin vacuum pipe is used, severe pressure adjustment is not required for the inside of the battery can 102, and the pressure adjustment is easy to carry out.

The volume of the pressure regulating container 64 is preferably much larger than that of the battery can 102 into which the electrolyte is filled. With such setting, pressure variations in the pressure regulating container 64 can be held sufficiently smaller than those in the battery can 102. Therefore, the operation of the pressure regulating mechanism 81 can be further stabilized. The desired volume of the pressure regulating container 64 is twice or more that of the battery can 102.

In addition, the pressure regulating mechanism 81 includes the cooling mechanism 82 and the drain 83. The provision of the cooling mechanism 82 and the drain 83 has the following advantage.

When the electrolyte in the battery can 102 volatilizes and enters the vacuum line 67, the electrolyte is cooled by the cooling mechanism 82 to be liquefied and is discharged through the drain 83. Therefore, the electrolyte having accidentally entered the vacuum line 67 is inhibited from reaching the vacuum pump 66. In general, the electrolyte contains fluorine. Accordingly, when the electrolyte reaches the vacuum pump 66, there arises a risk that the electrolyte may react with moisture contained in the atmosphere, thereby damaging the vacuum pump 66. Reliable discharge of the electrolyte through the drain 83 can reduce factors that may damage the vacuum pump 66.

After filling the electrolyte in the half of a total filling amount by the method of filling the electrolyte into the battery can 102 through the filling nozzle 68a while the pressure in the battery can 102 is reduced through the filling nozzle 68b, the operation of the filling nozzle 68a and the operation of the filling nozzle 68b are exchanged and the filling is further continued.

Stated in another way, in the continued filling, the gas in the battery can 102 is exhausted through the one hole 107 using the filling nozzle 68a while the electrolyte is filled into the battery can 102 through the other hole 107 using the filling nozzle 68b.

At that time, the electrolyte supplied to the hopper tank 62b via the electrolyte line is filled into the battery can 102 through the filling nozzle 68b. In addition, at that time, the gas in the battery can 102 is exhausted by the vacuum pump 66 through the filling nozzle 68a and the vacuum line 67, whereby the pressure in the battery can 102 is reduced.

Thus, since the filling can be performed by optionally employing one of the two holes 107 as the filling port, it is easier to uniformly impregnate the electrode laminate 103 with the electrolyte.

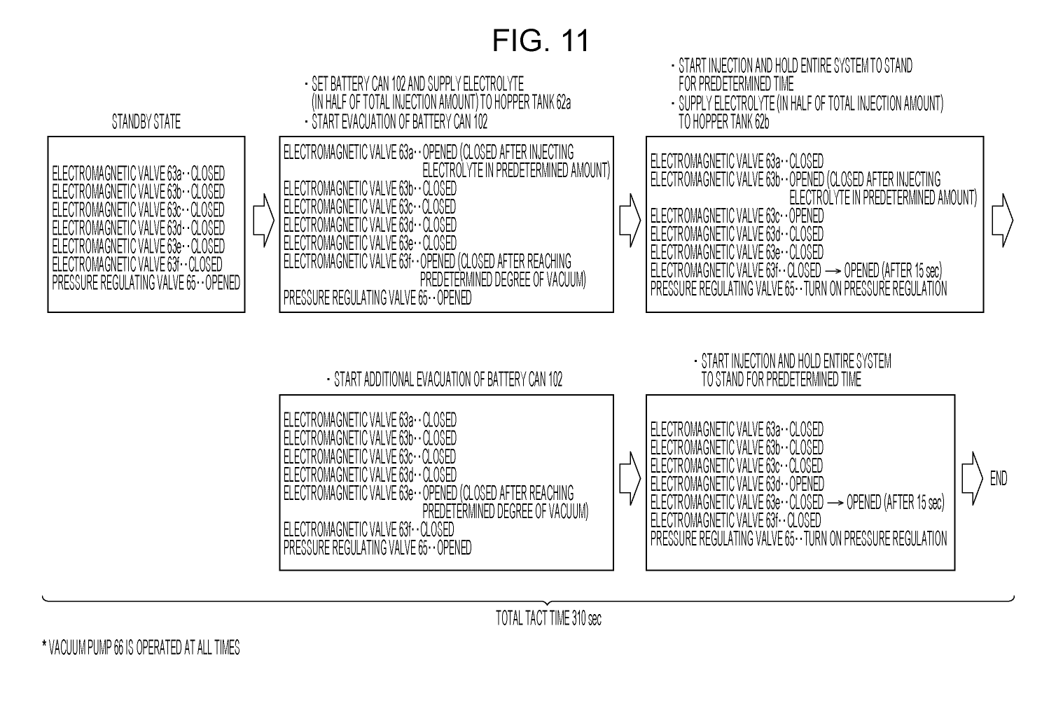

FIG. 11 illustrates a more practical example of on-off timings of the electromagnetic valves 63a to 63f and the pressure regulating valve 65 when the electrolyte is filled using the filling device 61. In the illustrated example, it is assumed that the vacuum pump 66 is operated at all times.

First, in a state before starting the filling, i.e., in a standby state, the electromagnetic valves 63a to 63f are all closed, and the pressure regulating valve 65 is opened.

Then, the battery can 102 is set as illustrated in FIG. 6, and the electrolyte is supplied to the hopper tank 62a. An amount of the electrolyte supplied to the hopper tank 62a at that time is equal to the half of the total amount of the electrolyte to be filled into the battery can 102. On that occasion, the electromagnetic valve 63a is opened until the supply of the electrolyte to the hopper tank 62a is completed, and the electromagnetic valve 63f is opened until the desired pressure is obtained in the battery can 102. The electromagnetic valves 63b to 63e are all closed, and the pressure regulating valve 65 is opened.

Then, the electromagnetic valve 63c is opened and the electrolyte supplied to the hopper tank 62a is filled into the battery can 102 through the one hole 107 using the filling nozzle 68a. Furthermore, at that time, the electromagnetic valve 63b is opened to supply the electrolyte to the hopper tank 62b. An amount of the electrolyte supplied to the hopper tank 62b is equal to the (remaining) half of the total amount of the electrolyte to be filled into the battery can 102. On that occasion, the electromagnetic valve 63f is initially closed, but it is opened after the lapse of a certain time (e.g., after the lapse of 15 sec). The opening and closing of the pressure regulating valve 65 are controlled such that the pressure in the region spanning from the inside of the battery can 102 to the vacuum line 67 is regulated to a proper level. The electromagnetic valves 63a, 63d and 63e are all closed.

Then, the inside of the battery can 102 is further depressurized (evacuated). On that occasion, the electromagnetic valve 63e is opened until the desired pressure is obtained in the battery can 102. The electromagnetic valves 63a to 63d and 63f are all closed, and the pressure regulating valve 65 is opened.

Then, the electrolyte supplied to the hopper tank 62b is filled into the battery can 102 through the other hole 107 using the filling nozzle 68b. At that time, the electromagnetic valve 63d is opened. Furthermore, the electromagnetic valve 63e is initially closed, but it is opened after the lapse of a certain time (e.g., after the lapse of 15 sec). The opening and closing of the pressure regulating valve 65 are controlled such that the pressure in the region spanning from the inside of the battery can 102 to the vacuum line 67 is regulated to a proper level. The electromagnetic valves 63a to 63c and 63f are all closed.

### [Configuration of Filling Device (Simplified Configuration)]

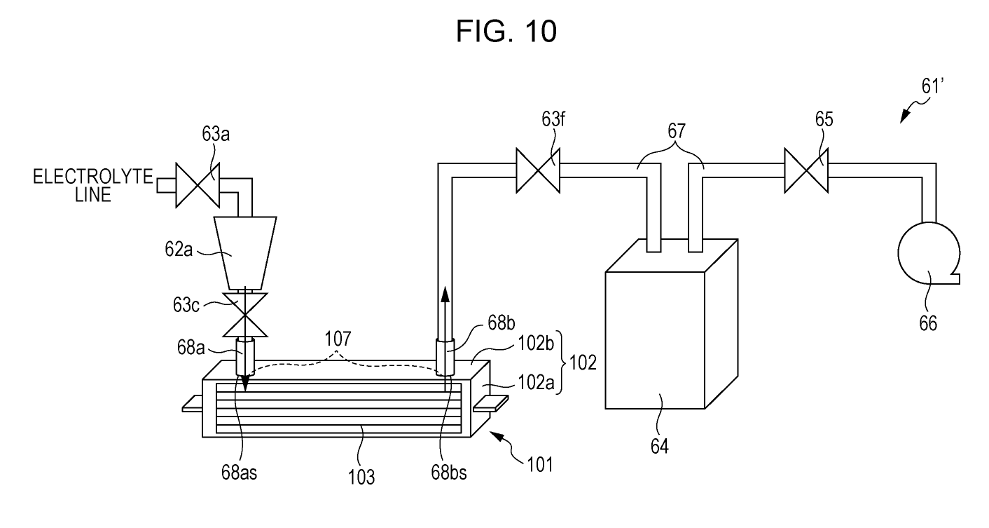

FIG. 10 is a perspective view illustrating a simplified modification of the configuration of the filling device illustrated in FIG. 6.

A filling device 61′ illustrated in FIG. 10 is constituted by simplifying the configuration of the filling device 61 illustrated in FIG. 6.

In more detail, the filling device 61′ includes, among the components of the filling device 61, the hopper tank 62a, the electromagnetic valves 63a, 63c and 63f, the filling nozzles 68a and 68b, the vacuum line 67 connected to the filling nozzle 68b, the pressure regulating container 64, the pressure regulating valve 65, and the vacuum pump 66.

In a similar manner to that in the filling device 61, the filling device 61′ fills the electrolyte, which is supplied to the hopper tank 62a through the electrolyte line, into the battery can 102 through the filling nozzle 68a fixed to one hole 107. Furthermore, in a similar manner to that in the filling device 61, the filling device 61′ exhausts the gas in the battery can 102 through the filling nozzle 68b, fixed to the other hole 107, and the vacuum line 67 by the vacuum pump 66, thereby reducing the pressure in battery can 102.

As a result, the filling device 61′ can also provide similar advantageous effects to those obtained with the filling device 61.

After filling the electrolyte, as described above, in the half of the total amount of the electrolyte to be filled, the filling nozzle 68b is fixed to the one hole 107, and the filling nozzle 68a is fixed to the other hole 107.

With such rearrangement, the electrolyte can be filled into the battery can 102 through the other hole 107 using the filling nozzle 68a, and the gas in the battery can 102 can be exhausted through the one hole 107 using the filling nozzle 68b.

Thus, since the filling can be performed by optionally employing one of the two holes 107 as the filling port, it is easier to uniformly impregnate the electrode laminate 103 with the electrolyte.

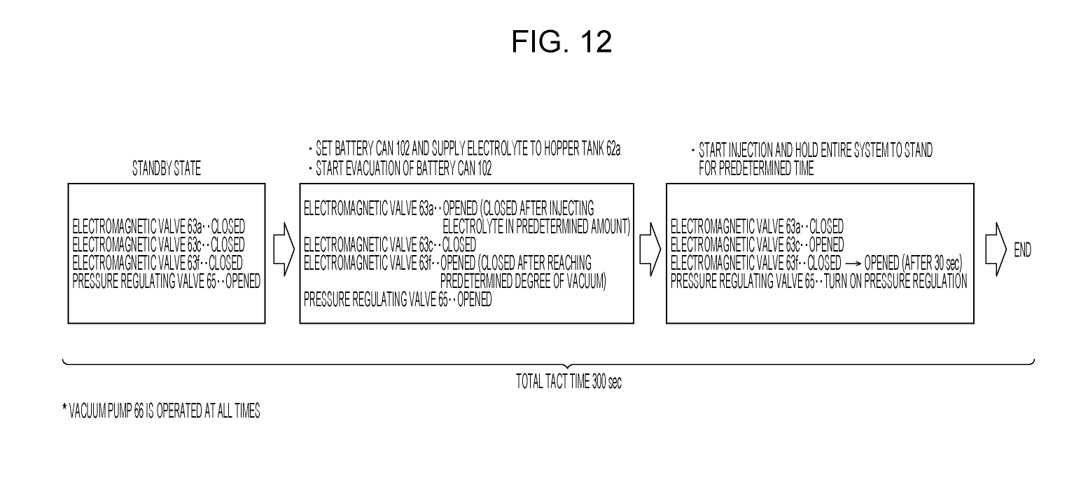

FIG. 12 illustrates a more practical example of on-off timings of the electromagnetic valves 63a, 63c and 63f and the pressure regulating valve 65 when the electrolyte is filled using the filling device 61′. In the illustrated example, it is assumed that the vacuum pump 66 is operated at all times.

In a standby state, the electromagnetic valves 63a, 63c and 63f are all closed, and the pressure regulating valve 65 is opened.

Then, the battery can 102 is set as illustrated in FIG. 10, and the electrolyte is supplied to the hopper tank 62a. An amount of the electrolyte supplied to the hopper tank 62a at that time is equal to a total amount of the electrolyte to be filled into the battery can 102. On that occasion, the electromagnetic valve 63a is opened until the supply of the electrolyte to the hopper tank 62a is completed, and the electromagnetic valve 63f is opened until the desired pressure is obtained in the battery can 102. The electromagnetic valve 63c is closed, and the pressure regulating valve 65 is opened.

Then, the electrolyte supplied to the hopper tank 62a is filled into the battery can 102 through the one hole 107 using the filling nozzle 68a. At that time, the electromagnetic valve 63c is opened. Furthermore, the electromagnetic valve 63f is initially closed, but it is opened after the lapse of 15 sec, for example.

### [Another Practical Example of Method for Fabricating Nonaqueous Secondary Battery]

### [Fabrication of Positive Electrode Plate]

A positive electrode plate is fabricated in the same manner as that described above in the practical example of the method for fabricating the nonaqueous secondary battery.

### [Fabrication of Negative Electrode Plate]

A negative electrode plate is fabricated in the same manner as that described above in the practical example of the method for fabricating the nonaqueous secondary battery.

### [Fabrication of Separator]

A separator is fabricated in the same manner as that described above in the practical example of the method for fabricating the nonaqueous secondary battery.

### [Preparation of Nonaqueous Electrolyte]

A nonaqueous electrolyte is prepared in the same manner as that described above in the practical example of the method for fabricating the nonaqueous secondary battery.

### [Fabrication of Battery Can]

SUS (Steel Special Use Stainless) plates are used as materials of the container-like case 102a and the cover member 102b, which constitute the battery can 102. The container-like case 102a has a wall thickness of 0.8 mm and a size of 330 mm (lengthwise direction)×157 mm (widthwise direction)×41 mm (depth) (internal dimensions). The cover member 102b has a thickness of 0.4 mm. Furthermore, as in the above-described practical example of the method for fabricating the nonaqueous secondary battery, the cover member 102b is formed in a saucer-like shape such that the cover member 102b is concavely fitted into the battery can 102.

The battery can 102 has the two holes 7 formed in the cover member 102b. The two holes 107 are each a circular hole having a diameter of 2.5 mm and are disposed at a spacing distance (corresponding to the spacing distance D1 illustrated in FIG. 1) of 328.4 mm between them.

### [Assembly of Secondary Battery]

A secondary battery is assembled in the same manner as that described above in the practical example of the method for fabricating the nonaqueous secondary battery. More specifically, five types of nonaqueous secondary batteries 101 were fabricated in accordance with the following EXAMPLES and COMPARATIVE EXAMPLES.

### Example A

The filling device 61′ was used. When the nonaqueous electrolyte was filled while the pressure in the battery can 102 was reduced by the vacuum pump 66, the pressure in the battery can 102 was temporarily reduced to 10 kPa. Thereafter, the electrolyte was filled through the filling nozzle 68a while the gas in the battery can 102 was exhausted through the filling nozzle 68b so as to maintain constant the pressure in the battery can 102 under control of the pressure regulating mechanism 81 with the function of suppressing pressure variations in the battery can 102 and improving pressure controllability. It is to be noted that the vacuum pump 66 preferably has a displacement of 20 liters or more per minute from the viewpoint of shortening a time of depressurization carried out prior to the filling (i.e., a time of initial evacuation).

### Example B

The filling device 61 was used. The half of the total filling amount of the electrolyte was filled with the same operation as that in EXAMPLE A. The remaining half of the total filling amount of the electrolyte was filled after exchanging the operation of the filling nozzle 68a and the operation of the filling nozzle 68b. Stated in another way, the electrolyte was filled through the filling nozzle 68b while the gas in the battery can 102 was exhausted through the filling nozzle 68a so as to maintain constant the pressure in the battery can 102 under control of the pressure regulating mechanism 81 with the function of suppressing pressure variations in the battery can 102 and improving pressure controllability.

### Comparative Example A

When reducing the pressure in the battery can 102 through one hole 107 by the vacuum pump 66 while the nonaqueous electrolyte was filled through the other hole 107, the pressure in the battery can 102 was reduced through the one hole 107 without employing the pressure regulating mechanism 81 (namely, by employing a device made up of a vacuum pipe, a vacuum gauge, an electromagnetic valve, and a vacuum pump).

### Comparative Example B

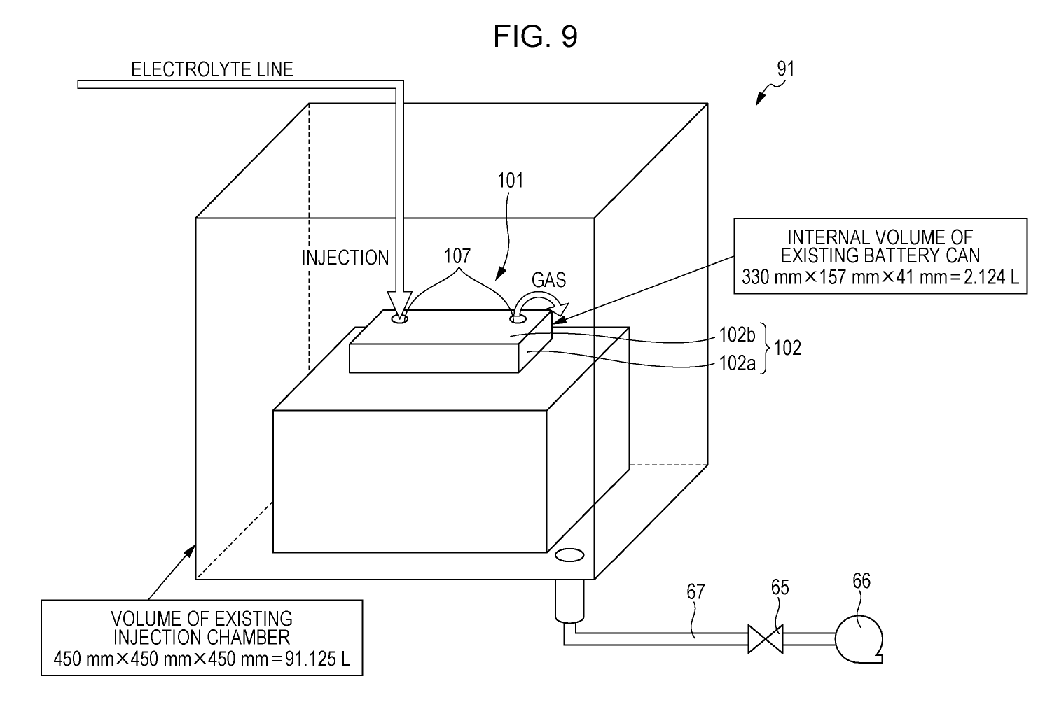

A pressure reducing chamber 91 illustrated in FIG. 9 was used, and the nonaqueous electrolyte was filled through only one of the two holes 107 after depressurizing the interiors of both the pressure reducing chamber 91 and the battery can 102 together.

### Comparative Example C

Only one hole was formed in the cover member of the battery can and the pressure reducing chamber 91 was employed. The nonaqueous electrolyte was filled through the one hole after depressurizing the interiors of both the pressure reducing chamber 91 and the battery can together.

[Comparison Results among EXAMPLES A and B and COMPARATIVE EXAMPLES A to C]

In COMPARATIVE EXAMPLE C, the pressure in the battery can rose due to gas generated upon the filling. As a result, a safety valve was burst.

On the other hand, one nonaqueous secondary battery according to each of EXAMPLE A, EXAMPLE B, COMPARATIVE EXAMPLE A, and COMPARATIVE EXAMPLE B was fabricated, and discharge capacity was confirmed by carrying out charge and discharge tests on the nonaqueous secondary battery at different C rates, i.e., at a 0.1 C rate and a 1 C rate. Table 1, given below, represents the discharge capacity at the 0.1 C rate, the discharge capacity at the 1 C rate, a rate characteristic defined by the following formula, and a tact time required for the filling.

Rate characteristic=discharge capacity at 1 C rate/discharge capacity at 0.1 C rate

TABLE 1

| | | Discharge | Discharge | | |
|---|---|---|---|---|---|
| | | Capacity at | Capacity at | Rate | |
| | Pattern | 0.1 C | 1 C | Characteristic | Tact Time |
| EXAMPLE A | After depressurization to 10 kPa, | 141.10 Ah | 137.01 Ah | 0.971 | 300 sec |
| | pressure was further | | | | |
| | gradually reduced through | | | | |
| | one hole while electrolyte | | | | |
| | was filled through the other | | | | |
| | hole. | | | | |
| EXAMPLE B | After filling electrolyte in 1/2 | 142.25 Ah | 139.77 Ah | 0.983 | 310 sec |
| | of total amount by method | | | | |
| | in EXAMPLE A, electrolyte | | | | |
| | was filled again after | | | | |
| | exchanging hole for | | | | |
| | pressure reduction and hole | | | | |
| | for filling. | | | | |
| COMPARATIVE | Gas was exhausted without | 135.9 Ah | 129.1 Ah | 0.950 | 300 sec |
| EXAMPLE A | using pressure regulating | | | | |
| | mechanism. | | | | |
| COMPARATIVE | After depressurization to 10 kPa | 105.9 Ah | 96.1 Ah | 0.907 | 1200 sec |
| EXAMPLE B | in pressure reducing | | | | |
| | chamber, electrolyte was | | | | |
| | filled through only one hole. | | | | |
| COMPARATIVE | In battery including cover | No data | No data | No data | Safety valve |
| EXAMPLE C | member with one hole, | | | | was burst |
| | electrolyte was filled after | | | | |
| | depressurization to 5 kPa in | | | | |
| | pressure reducing chamber. | | | | |

As seen from Table 1, satisfactory capacity was obtained as a result of confirming the discharge capacity at the 0.1 C rate on EXAMPLES A and B in each of which the pressure in the battery can 102 was reduced through one hole 107 by employing the pressure regulating mechanism 81 while the electrolyte was filled through the other hole 107. Regarding the rate characteristic, a satisfactory result was also obtained in each of EXAMPLES A and B. In particular, the best rate characteristic was obtained in EXAMPLE B. Regarding the tact time, a remarkable time reduction was achieved in each of EXAMPLES A and B in comparison with COMPARATIVE EXAMPLE B.

On the other hand, in COMPARATIVE EXAMPLE A, because control of the pressure in the battery can 102 was insufficient during the filling, the degree of vacuum in the battery can 102 reached 10 kPa at the moment of opening the electromagnetic valve in the vacuum line. Thereafter, pressure control to a stable level was not succeeded in spite of trying to control the pressure in the battery can 102 to 10 kPa with the pressure regulating valve. Accordingly, the desired rate characteristic was not obtained in the charge and discharge tests. Furthermore, an intrusion of the electrolyte to the vacuum line from the inside of the battery can 102 occurred, and the electrolyte could not be filled in the desired amount. Thus, the charge and discharge tests provided only the result that the discharge capacity was insufficient.

In COMPARATIVE EXAMPLE B, the filling was performed in a state where the filling nozzle was inserted in one of the two holes 107, and the other hole 107 was held open. However, the pressure in the battery can 102 rose to a higher level than in the pressure reducing chamber 91. As a result, a difficulty occurred in filling the electrolyte into the battery can 102 during the filling and further in filling the predetermined amount of the electrolyte. Thus, infiltration of the electrolyte into the electrode laminate 103 was insufficient, and the desired discharge capacity was not obtained.

In COMPARATIVE EXAMPLE C, during the course of feeding the electrolyte under pressure, the pressure in the battery can rose excessively, whereby the safety valve was burst and the function of the battery was lost.

Additionally, it is thought that, when the filling is performed using the pressure reducing chamber 91, the pressure (degree of vacuum) in the battery can 102 can be controlled by employing the pressure regulating mechanism 81 if the volume of the pressure reducing chamber 91 is sufficiently larger than that of the battery can 102 having the two holes 107. On the other hand, it is also thought that gas flow in the battery can 102 is reduced in comparison with the case using the filling device 61, and that sufficient impregnation of the electrode laminate 103 with the electrolyte is not easy to realize.

### [Recapitulation of Filling Device and Filling Method for Nonaqueous Secondary Battery]

The filling device and the filling method for the nonaqueous secondary battery according to the above-described embodiment can also be construed as follows.

Hitherto, it has been difficult to provide a nonaqueous secondary battery as a product having stable quality for the reason that a path of a vacuum line is thin and pressure control is hard to carry out during the filling. Furthermore, when the electrolyte is filled from the lower side of the nonaqueous secondary battery, there has been a risk that sealing-off of a hole by laser welding may be insufficient due to leakage of the electrolyte and attachment of the electrolyte to the hole and thereabout.

In view of those problems, the pressure regulating mechanism 81 for stabilizing the pressure is disposed in the vacuum line 67 so that the pressure can be easily stabilized. Moreover, since the holes 107 are formed in the cover member 102b, a risk of leakage of the electrolyte and a risk of attachment of the electrolyte to the holes 107 are greatly reduced.

As a result, in manufacturing the nonaqueous secondary battery with large capacity, a filling speed is increased and productivity is improved. Furthermore, since the degree of vacuum during the filling is stabilized, quality of the nonaqueous secondary battery is also stabilized.

Stated in another way, the filling method and the filling device according to the embodiment can be construed as being related to a lithium secondary battery including an electrode group in which a positive electrode plate and a negative electrode plate are laminated in plural layers with a separator interposed therebetween, a battery can in which the electrode group is set and an electrolyte is filled, positive and negative current collection terminals electrically connecting the positive and negative electrode plates to respective external terminals, and a cover member fitted to the battery can, the cover member having a plurality of filling holes formed therein. In such a lithium secondary battery, when the filling is performed using the filling holes, the electrolyte is filled through one of the filling holes, and pressure in the battery can is reduced through the other filling hole(s), the pressure reduction being performed by employing a buffer tank to adjust the pressure in the battery can. Preferably, the buffer tank has a volume twice or more that of the battery can.

When the electrolyte is filled through the filling nozzle 68a, the pressure is reduced through the filling nozzle 68b and the pressure regulating mechanism 81. The pressure regulating mechanism 81 can reduce again the pressure that has risen due to volatilization of the electrolyte upon the filling, and can smooth supply of the electrolyte to the electrode laminate 103. Furthermore, employing the pressure regulating mechanism 81 is effective in preventing excessive pressure reduction in the battery can 102, and preventing volatilization of the electrolyte having the low boiling point. As a result, it is possible to avoid change of the composition of the electrolyte, and to realize significant stabilization of quality.

The pressure in the pressure regulating container 64 is regulated by the pressure regulating valve 65, and the volume of the pressure regulating container 64 is set to be sufficiently larger than that of the battery can 102 such that abrupt pressure variations will not generated even when the pressure in the battery can 102 is reduced.

In addition, halfway the filling, the nozzle through which the electrolyte is filled is exchanged from the filling nozzle 68a to the filling nozzle 68b, and the nozzle through which the evacuation (pressure reduction) is performed is exchanged from the filling nozzle 68b to the filling nozzle 68a. Such exchange of the filling nozzle enables the electrode laminate 103 to be more satisfactorily impregnated with the electrolyte.

It is to be noted that the present invention is not limited to the above-described embodiments, and that the present invention can be variously modified within the scope defined in claims. Other embodiments obtained by properly combining the technical means, disclosed in the above-described different embodiments, with each other are also involved within the technical scope of the present invention.

The present invention can be widely applied to a nonaqueous secondary battery and a filling method for the nonaqueous secondary battery.

What is claimed is:

1. A nonaqueous secondary battery comprising:
an electrolyte;
an electrode laminate in which a positive electrode plate and a negative electrode plate are laminated with a separator interposed therebetween;
a battery can containing the electrolyte and the electrode laminate; and
a plurality of current collection terminals electrically connected to the positive electrode plate and the negative electrode plate,
the battery can having a plurality of holes with the function of a filling port for filling the electrolyte into the battery can therethrough and the function of an exhaust port for exhausting gas in the battery can therethrough,
wherein at least one of the holes is formed at a position that is at a higher level than a surface of the electrolyte in use of the nonaqueous secondary battery, and that is not overlapped with the electrode laminate.

2. The nonaqueous secondary battery according to claim 1, further comprising a film material covering surfaces of the electrode laminate where the current collection terminals are not disposed,
wherein the film material is made of a material through which the electrolyte is impermeable.

3. The nonaqueous secondary battery according to claim 1, wherein the at least one hole is formed at a position not overlapping with the current collection terminals.

4. The nonaqueous secondary battery according to claims 1, wherein the battery can includes a container-like case and a cover member serving as a cover of the container-like case, and
the at least one hole is formed in the cover member.

5. The nonaqueous secondary battery according to claims 1, wherein a spacing distance between two of the holes is larger than a size of the electrode laminate measured in a direction parallel to a segment interconnecting the two holes.

6. The nonaqueous secondary battery according to claims 1, wherein the plural current collection terminals are disposed side by side at one surface of the electrode laminate.

7. The nonaqueous secondary battery according to claims 1, further comprising:
a plurality of external terminals disposed on the battery can and each electrically connected to corresponding one of the plural current collection terminals; and
wires electrically connecting the current collection terminals and the external terminals, respectively,
wherein the wires are laid to extend along and near an inner wall of the battery can.

8. A filling method comprising the step of, when the nonaqueous secondary battery according to claims 1 is manufactured, exhausting gas in the battery can through one of any two of the holes and generating a pressure-reduced atmosphere in the battery can while the electrolyte is filled into the battery can through the other of the two holes.

9. The filling method according to claim 8, wherein the battery can is placed such that the two holes are positioned at different heights and that an upper one of the two holes is positioned at a higher level than the electrode laminate, and
the gas is exhausted through the upper hole.
